(19) United States
(12) Patent Application Publication
(10) Pub. No.: US 2007/0104440 A1
(43) Pub. Date: May 10, 2007

(54) Fabrication of polymer waveguide using a mold

(76) Inventors: Mal-soon Kim, Kunpo-si (KR); Jung-Woo Yun, Yongin-si (KR); Jung-Hyun Oh, Seoul (KR)

Correspondence Address: ANDERSON, KILL & OLICK, P.C., 1251 AVENUE OF THE AMERICAS, NEW YORK,, NY, 10020-1182, US

(21) Appl. No.: 10/579,660

(22) PCT Filed: Mar. 12, 2004
(86) PCT No.: PCT/KR04/00518

§ 371 Date: May 17, 2006

(30) Foreign Application Priority Data
Dec. 31, 2003 (KR) 10-2003-0101171

(51) Int. Cl. G02B 6/10; B29D 11/00

(52) U.S. Cl. 385/129; 264/1.24

(57) ABSTRACT

A polymer waveguide having low optical loss and no lip around a core is prepared by using a mold having a recessed shape formed by assembling at least two waveguide pattern units having predesigned channels together with two band parts such that the channels of the units are interconnected and open to the band parts, and filling the void generated by contacting the mold and a under cladding layer with a photocurable polymeric resin to form a core layer.

### FIELD OF THE INVENTION

The present invention relates to a method for preparing a polymer waveguide comprising a core and at least one cladding layer, the waveguide having low optical loss and no lip around its core, using a mold having a recessed shape for forming the core pattern.

### BACKGROUND OF THE INVENTION

Multi-mode optical waveguides comprising an under cladding layer, a core layer which serves as a multi-mode transport channel and an upper cladding layer are employed in short distance communication, e.g., LAN (local area network), building network, access network, optical backplane and optical interconnection. Such optical waveguides have been produced using an inexpensive polymer such as polyimides, epoxides and acrylates instead of silica.

Further, various techniques have been reported by Jenoptik Mikrotechnik GmbH. in Germany, and Chou at Prinston University and Whiteside at Harvard University in United States, which produce a core layer by press-embossing or stamping. These conventional methods, however, are hampered by the problem that a lip is formed around the core, which causes increased optical loss of the waveguide.

### SUMMARY OF THE INVENTION

Accordingly, it is a primary object of the present invention to provide an efficient and simple method for preparing a polymer waveguide having no lip around its core.

In accordance with the present invention, there is provided a method for preparing a polymer waveguide composed of an under cladding, a core and an upper cladding layers, comprising:

1) forming the under cladding coating layer on a substrate;

2) placing above the under cladding layer a mold having the shape formed by assembling at least two waveguide pattern units having predesigned channels and two band parts such that the channels of the units are interconnected and open to the two band parts, in such a way that the recess of the mold and the under cladding layer face each other to form a void therebetween;

3) injecting a photocurable polymeric resin through one end of the two band parts to fill the void with the resin and photocuring the resin to form the core layer, and removing the mold from the under cladding layer; and

4) forming the upper cladding coating layer on the core layer.

### BRIEF DESCRIPTION OF THE DRAWINGS

The above and other objects and features of the present invention will become apparent from the following description of the invention, when taken in conjunction with the accompanying drawings, which respectively show:

FIG. 1: a waveguide pattern unit (10) for a multi-mode splitter unit (FIG. 1A), and the assembly of twelve waveguide pattern units and two band parts (20) (FIG. 1B), obtained in Example 1; and

FIG. 2: scanning electron microscope (SEM) scans (FIGS. 2A and 2B) and an atomic microscope scan (FIG. 2C) of the core of the polymer waveguide obtained in Example 5.

### DETAILED DESCRIPTION OF THE INVENTION

The inventive method for preparing a polymer waveguide is characterized by stamping to generate a waveguide pattern, by way of using a mold having a recessed shape formed by assembling at least two waveguide pattern units having predesigned channels together with two band parts such that the channels of the units are interconnected and open to the band parts, and filling the void generated by contacting the mold and a under cladding layer with a photocurable polymeric resin to form a core layer.

The band part in the mold has a depth identical to that of the waveguide pattern. When the waveguide pattern and band part have different depths, a significant problem occurs during the step of binding a dummy sheet following the formation of an upper cladding layer.

The inventive mold may be a rubber or metal mold prepared by a conventional photolithography or LIGA (Lithographie Galvanoformung Abformung) technique. For example, a rubber mold may be prepared by pouring a siloxane-based resin(e.g., polydimethylsiloxane rubber) on a master having a projection which is prepared by a photolithography or LIGA technique, leaving it at room temperature to remove bubbles therefrom, and then, curing at a temperature ranging from 30 to 100° C. for 2 to 10 hrs. A metal mold may be prepared in a similar way by emboding a desired recess on a metal (e.g., nickel) plate using an LIGA technique.

In the process of forming a metal mold, a hole opening for resin injection or withdrawal is formed at the end part of the band part, and if necessary, the mold may be nickel plated.

The inventive polymer waveguide is prepared by forming an under cladding coating layer on a substrate; placing the prepared mold above the under cladding layer in such a way that the recess of the mold and the under cladding layer face each other to form a void therebetween; injecting a photocurable polymeric resin through one end of the two band parts to fill the void with the resin, and photocuring the resin to form a core layer, and removing the mold from the under cladding layer; and forming an upper cladding coating layer on the core layer. The end of the other band part is used for evacuation of the void during or after the injection of the photocurable polymeric resin.

In case a transparent rubber mold is used, the polymeric resin may be cured by UV irradiating from the mold side regardless of the transparency of the substrate, while the use of a metal mold necessarily requires the use of a transparent substrate. After completion of the formation of the core layer, the isolated rubber mold may be reused at least ten times, while a metal mold may be reused almost perpetually.

The under and upper cladding layers may be formed by a conventional coating method, e.g., spin coating, followed by a conventional curing method, e.g., UV irradiation, and are made of a photocurable polymeric resin having a lower refractive index than that of the core layer resin.

The photocurable polymeric resin which is used in the present invention may be a conventional resin composition for a waveguide, preferably the composition disclosed by the present inventors in Korean Patent Publication No. 2003-71343.

The substrate which may be used in the present invention include silicon wafers, and transparent acrylic plates and glass plates.

The inventive photocurable polymer waveguide comprises a core with no lip, having a width and a depth of 50 to 1000 μm, and an improved surface roughness of at least 0.5 nm(rms), thereby exhibiting a low optical loss ranging from 0.05 to 0.3 dB/cm at 850 nm.

The prepared polymer waveguide provides waveguide device units through subsequent steps, i.e., binding of dummy sheet, dicing and polishing steps.

The following Examples are given for the purpose of illustration only, and are not intended to limit the scope of the invention.

### EXAMPLE 1

### Design of an Assembly for a Mold

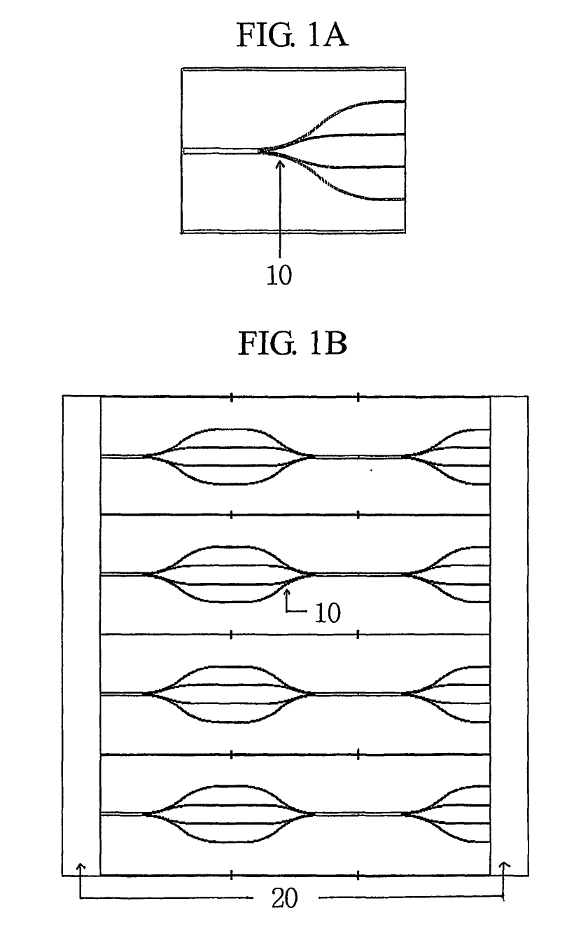

A waveguide pattern unit (10) was designed in the form of a cascade-type 1×4 multi-mode splitter unit having a width×length of 65 mm×70 mm, wherein one major channel (400 μm×200 μm (width×depth)) splits into four branch channels (200 μm×200 μm (width×depth)) as shown in FIG. 1A. Twelve of such units were arranged in a four row×three column configuration together with two rectangular band parts (20) having a width×length of 5 mm×5 mm and a depth of 200 μm such that the channels of the units in each row were interconnected with each other and also to the two bands, as shown in FIG. 1B, to obtain an assembly for a mold.

Preparation of a Mold

### EXAMPLE 2

### Preparation of a Rubber Mold—1

A photomask was prepared using the assembly obtained in Example 1. An SU-8 photoresist was coated on a silicon wafer, dried and light-exposed using a mask-aligner and the prepared photomask, and treated with a developer, to prepare an embossing photoresist master. An aluminum tape wall was installed on the circumference of the master. A polydimethylsiloxane rubber was poured thereto, kept at room temperature to remove bubbles therefrom, and cured at 50° C. for 3 hrs, to obtain a rubber mold having a recessed shape.

### EXAMPLE 3

### Preparation of a Rubber Mold—2

A photomask was prepared using the assembly obtained in Example 1. The photomask was placed on a 5 mm thick nickel metal plate and subject to LIGA, to prepare an embossing master. For enhancing the surface roughness, the master was nickel plated and polished. An aluminum tape wall was installed on the circumference of the master. A polydimethylsiloxane rubber was poured thereto, kept at room temperature to remove bubbles therefrom, and cured at 50° C. for 3 hrs, to obtain a rubber mold having a recessed shape.

### EXAMPLE 4

### Preparation of a Metal Mold—3

A photomask was prepared using the assembly obtained in Example 1. The photomask was placed on a 5 mm thick nickel metal plate and subject to LIGA, to prepare a metal mold having a recessed shape. For enhancing the surface roughness, the mold was nickel plated and polished. Further, two 1 mm diameter holes opening to the two band parts were formed at the respective ends of the band parts.

Preparation of a Polymer Waveguide

### EXAMPLE 5

### Preparation of a Polymer Waveguide Using a Rubber Mold—1

A photocurable resin composition having a refractive index of 1.40 was uniformly spread on a silicon wafer, spin-coated at 3000 rpm for 30 seconds, cured with a 100 mJ/cm² UV fusion lamp and treated at 60˜100° C. for 10 minutes, to form an under cladding layer, wherein the photocurable resin composition was a mixture of 40 g of a urethane oligomer substituted with fluorine (an oligomer synthesized from a mixture of 375.27 g of Fluorolink D, 89.38 g of isophorondiisocyanate and 34.85 g of hydroxymethacrylate), 20 g of SR-339, 20 g of 2-perfluorooctylethylacrylate, 10 g of 2-hydroxypropylacrylate, 4.5 g of Darocure #1173, 5 g of Z-6030 and 0.5 g of BHT, as disclosed in Example 5 of Korean Patent Publication No. 2003-71343.

The rubber mold obtained in Example 2 or 3 was placed above the under cladding layer such that the recess of the mold and the under cladding layer faced each other to form a void therebetween. A photocurable resin composition having a refractive index of 1.45 was injected through one end of the band parts using an injector, wherein the photocurable resin composition was a mixture of 40 g of a urethane oligomer substituted with fluorine (an oligomer synthesized from a mixture of 375.27 g of Fluorolink D, 89.38 g of isophorondiisocyanate and 38.9 g of 2-hydroxypropylacrylate), 30 g of SR-339, 20 g of 2-perfluorooctylethylacrylate, 4.5 g of Darocure #1173, 5 g of Z-6030 and 0.5 g of BHT, as disclosed in Example 10 of Korean Patent Publication No. 2003-71343. When the band injected with the resin was more or less filled with the resin, the end of the other band part was evacuated with a vacuum pump. When the void was filled with the resin, the resin was cured with a 100 mJ/cm² UV fusion lamp from the mold side, and treated at 60˜100° C. for 10 minutes, to form a core layer.

The photocurable resin composition having a refractive index of 1.40 which was used in the preparation of the under cladding layer was spin-coated on the core layer at 1000 rpm for 20 seconds, cured with a 100 mJ/cm² UV fusion lamp and treated at 60˜100° C. for 10 minutes, to form an upper cladding layer, thereby obtaining a polymer waveguide.

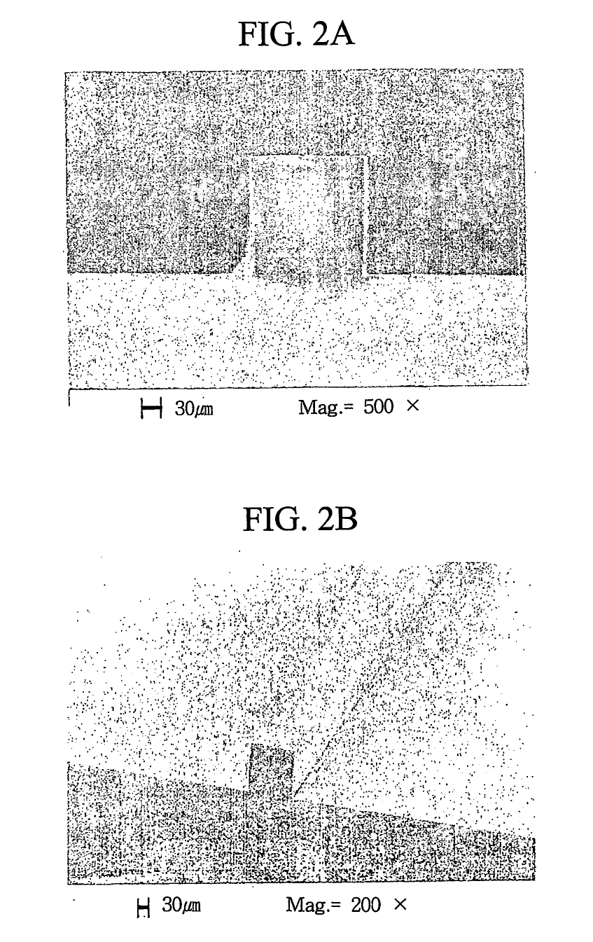

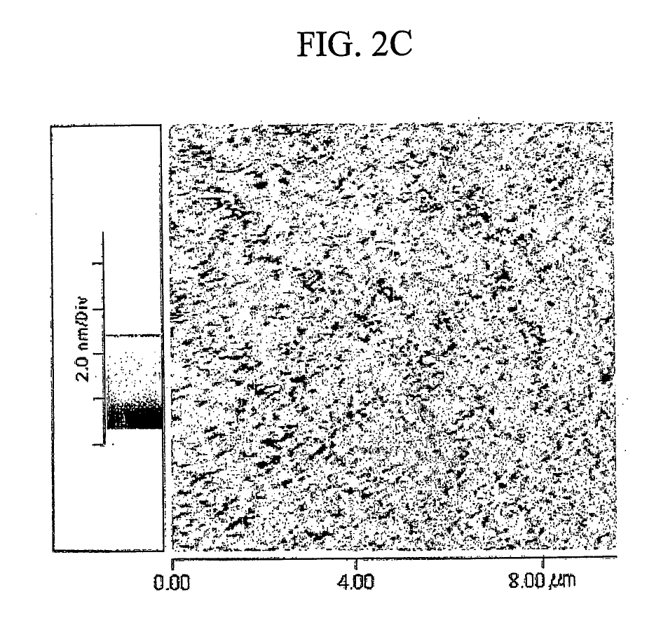

Scanning electron microscope (SEM) scans of the core of the polymer waveguide obtained are shown in FIGS. 2A (×500) and 2B (×200), and an atomic microscope scan thereof, in FIG. 2C. It is confirmed from FIG. 2 that the core layer of the inventive waveguide has no lip and has an improved surface roughness.

### EXAMPLE 6

### Preparation of a Polymer Waveguide Using a Rubber Mold—2

The procedure of Example 5 was repeated except that a flat acrylic plate was used instead of the silicon wafer, to prepare a polymer waveguide.

### EXAMPLE 7

### Preparation of a Polymer Waveguide Using a Metal Mold—3

The procedure of Example 5 was repeated except that a flat acrylic plate and the metal mold obtained in Example 4 were used instead of the silicon wafer and the rubber mold, respectively, to prepare a polymer waveguide.

### EXAMPLE 8

### Preparation of a Polymer Waveguide Using a Metal Mold—4

The procedure of Example 7 was repeated except that a flat glass plate was used instead of the acrylic plate, to prepare a polymer waveguide.

### EXAMPLE 9

### Characteristics of Polymer Waveguides

The characteristics of the polymer waveguide obtained in Example 5 in terms of specific refractive index and insertion loss were measured, the insertion loss being determined using a 850 nm light source and a polymer clad silica fiber having the same size as that of the core of the prepared waveguide. The results are shown in Table 1.

TABLE 1

Waveguide of Example 5

| Difference of Specific | 3.45 | | | |
|---|---|---|---|---|
| Refractive Index (%) | | | | |
| Insertion Loss (dB) | 1 | 2 | 3 | 4 |
| per divergence | 6.46 | 6.29 | 6.10 | 7.17 |

As can be seen from Table 1 and the above description, the present invention provides a very simple and efficient method for mass-producing at a low manufacturing cost a polymer waveguide, especially a multi-mode waveguide, having no lip around the core and exhibiting low optical loss.

While the invention has been described with respect to the above specific embodiments, it should be recognized that various modifications and changes may be made to the invention by those skilled in the art which also fall within the scope of the invention as defined by the appended claims.
What is claimed is:

1. A method for preparing a polymer waveguide composed of an under cladding, a core and an upper cladding layers, comprising:
1) forming the under cladding coating layer on a substrate;
2) placing above the under cladding layer a mold having the shape formed by assembling at least two waveguide pattern units having predesigned channels and two band parts such that the channels of the units are interconnected and open to the two band parts, in such a way that the recess of the mold and the under cladding layer face each other to form a void therebetween;
3) injecting a photocurable polymeric resin through one end of the two band parts to fill the void with the resin and photocuring the resin to form the core layer, and removing the mold from the under cladding layer; and
4) forming the upper cladding coating layer on the core layer.

2. The method of claim 1, wherein the end of the other band part is evacuated during or after the injection of the photocurable polymeric resin.

3. The method of claim 1, wherein the waveguide pattern and band part have a same depth.

4. The method of claim 1, wherein the mold is a rubber or metal mold prepared by a photolithography or LIGA (Lithographie Galvanoformung Abformung) technique.

5. The method of claim 1, wherein the substrate is selected from the group consisting of a silicon wafer, an acylic plate and a glass plate.

6. A polymer waveguide having no lip around the core, which is prepared by the method of claim 1.

7. The polymer waveguide of claim 6 which comprises a core having a width and a depth ranging from 50 to 1,000 μm.

8. The mold used in the method of claim 1.
